(19) United States
(12) Patent Application Publication
(10) Pub. No.: US 2026/0342215 A1
(43) Pub. Date: Oct. 29, 2026

(54) POWER FEEDING DEVICE

(71) Applicant: SINFONIA TECHNOLOGY CO., LTD., Tokyo (JP)

(72) Inventor: Nobuhiro ARAKI, Tokyo (JP)

(73) Assignee: SINFONIA TECHNOLOGY CO., LTD., Tokyo (JP)

(21) Appl. No.: 19/157,621

(22) PCT Filed: Oct. 27, 2023
(86) PCT No.: PCT/JP2023/038942

§ 371 Date: Aug. 18, 2025

(30) Foreign Application Priority Data
Feb. 20, 2023 (JP) 2023-024271

(51) Int. Cl. H02M 1/32; H02M 1/00; H02M 7/493; H02M 7/5387

(52) U.S. Cl. CPC H02M 1/325; H02M 1/007; H02M 7/493; H02M 7/53871

(57) ABSTRACT

A power feeding device supplies electric power to track circuits. The power feeding device includes a plurality of power supply circuits including pluralities of switching elements and electrically connected to a power supply and the track circuits and electrically connected to each other in parallel, and a driving controller that controls driving of the pluralities of switching elements to thereby control supply of electric power to the track circuits by the plurality of power supply circuits.

### TECHNICAL FIELD

The present invention relates to a power feeding device that supplies electric power to a load.

### BACKGROUND ART

There is known a power feeding device that supplies electric power to a load. As such a power feeding device, for example, as disclosed in Patent Literature 1, there is known a power supply system that supplies electric power to a mobile body that travels while being supported by a track.

The power supply system disclosed in Patent Literature 1 includes a capacitor connected to a power feeding line to constitute a resonance circuit in conjunction with the power feeding line, a switch circuit including a switch element that selectively takes an ON state in which a reactor is connected to the power feeding line in parallel and an OFF state in which the reactor is not electrically connected to the power feeding line, and switching control means for switching a state of the switch element.

### CITATION LIST

### Patent Literature

Patent Literature 1: Japanese Patent Laid-Open No. 2009-201211

### SUMMARY OF INVENTION

### Technical Problem

In a power feeding device such as the power supply system disclosed in Patent Literature 1, when the switch element (a switching element) has failed, in general, the power supply to the load is stopped. However, depending on a traveling state or an operation of the mobile body, it is not desired to stop the power supply to the load. For that reason, there is a demand for a power feeding device in which power supply to the load is not stopped even when the switching element has failed.

An object of the present invention is to provide a power feeding device in which power supply to a load is not stopped even if a switching element has failed.

### Solution to Problem

A power feeding device according to an embodiment of the present invention is a power feeding device that supplies electric power to a load. The power feeding device includes a plurality of power converters including pluralities of switching elements and electrically connected to a power supply and the load and electrically connected to one another in parallel, and a driving controller that controls driving of the pluralities of switching elements to thereby control supply of electric power to the load by the plurality of power converters (a first configuration).

Accordingly, by driving the pluralities of switching elements in the plurality of power converters electrically connected to one another in parallel, electric power can be supplied from the plurality of power converters to the load. Thus, even when the switching element has failed in a subset of the plurality of power converters, by driving the pluralities of switching elements in the other power converters with the driving controller, electric power can be supplied from the other power converters to the load.

Therefore, even when the switching element has failed in a subset of the plurality of power converters, electric power can be continuously supplied from the power feeding device to the load.

In the first configuration, the driving controller controls driving of the pluralities of switching elements in the plurality of power converters respectively such that electric currents output from the plurality of power converters are different for each of the power converters (a second configuration).

Accordingly, different electric currents can be output from the plurality of power converters. Thus, degrees of deterioration of the pluralities of switching elements in the respective power converters can be made different. Therefore, occurrence timing of failure of the switching elements can be changed in the plurality of power converters.

Thus, the switching elements of the power converters can be prevented from simultaneously failing. Therefore, even when the switching element in a subset of the plurality of power converters has failed, electric power can be continuously supplied from the power feeding device to the load.

In the second configuration, when the switching element in a subset of the plurality of power converters has failed, the driving controller controls driving of the pluralities of switching elements in the power converters not in failure to control electric currents output from the power converters not in failure (a third configuration).

Accordingly, when the switching element in a subset of the plurality of converters has failed, by driving the pluralities of switching elements of the power converters not in failure, electric power can be supplied from the power converters not in failure to the load.

Therefore, even when the switching element in a subset of the plurality of converters has failed, electric power can be continuously supplied from the power feeding device to the load.

In the first configuration, each of the plurality of power converters includes a switching circuit configured by the plurality of switching elements, a capacitor provided further on the power supply side than the switching circuit and electrically connected to the power supply in parallel, and a current breaker provided further on the power supply side than the capacitor and capable of, when the switching element in a subset of the plurality of power converters has failed, interrupting a return current flowing from the switching circuit side to the power supply side in the subset of power converters (a fourth configuration).

Consequently, even when the switching element in a subset of the plurality of power converters has failed and the switching circuit falls into a short circuit state, a return current flowing from the remaining power converters to the power supply side via the switching circuit of the subset of power converters can be interrupted by the current breaker. Thus, even when the switching element in a subset of the plurality of power converters electrically connected in parallel has failed, the power supply side of the power feeding device can be prevented from being damaged.

Moreover, since the current breaker is located further on the power supply side than the capacitor located on the power supply side with respect to the switching circuit, when an electric current is supplied from the power supply to the capacitor to charge the capacitor, the electric current can be interrupted by the current breaker. Thus, when the capacitor is charged, an inrush current can be prevented from flowing into the capacitor.

In the first configuration, each of the plurality of power converters includes a failure part detector capable of detecting the switching element in failure among the plurality of switching elements (a fifth configuration).

Accordingly, when the switching element in a subset of the plurality of power converters has failed, which switching element has failed in the subset of power converters can be easily detected. Thus, the switching element in failure can be easily replaced. Therefore, even when the switching element of the power converter has failed, the power converter can be quickly restored.

### Advantageous Effects of Invention

A power feeding device according to an embodiment of the present invention includes a plurality of power converters including pluralities of switching elements and electrically connected to a power supply and a load and electrically connected to one another in parallel, and a driving controller that controls driving of the pluralities of switching elements to thereby control supply of electric power to the load by the plurality of power converters.

Accordingly, even when the switching element has failed in a subset of the plurality of power converters, electric power can be continuously supplied from the power feeding device to the load.

### BRIEF DESCRIPTION OF DRAWINGS

FIG. 1 is a diagram illustrating a schematic configuration of a power supply system including a power feeding device and a plurality of track circuits according to a first embodiment.

FIG. 2 is a diagram illustrating, as functional blocks, components of a chopper driving controller.

FIG. 3 is a diagram illustrating an example of a relation between a primary side voltage of a transformer and an output current of a power supply circuit.

FIG. 4 is a diagram illustrating an example of a waveform of a command signal for instructing, when one switching element for chopper is in an ON state, the other switching element for chopper to be in an OFF state.

FIG. 5 is a diagram illustrating an example of a waveform of a command signal for instructing, when one switching element for chopper is in the OFF state, the other switching element for chopper to be in the ON state.

FIG. 6 is a diagram illustrating a schematic configuration of a power supply system including a power feeding device according to a second embodiment.

FIG. 7 is a diagram illustrating a schematic configuration of a power supply system including a power feeding device according to a third embodiment.

FIG. 8 is a functional block diagram schematically illustrating components of a failure detector.

FIG. 9 is a schematic diagram illustrating a relation between a driving signal and an output signal of a switching element.

FIG. 10 is a schematic diagram illustrating a relation between a signal input to a logic circuit and a determination signal.

FIG. 11 is a schematic diagram illustrating a relation between a signal input to a logic circuit and a determination signal.

FIG. 12 is a diagram illustrating a schematic configuration of a power supply system including a power feeding device according to a fourth embodiment.

FIG. 13 is a diagram illustrating a schematic configuration of a power supply system including a power feeding device according to a fifth embodiment.

FIG. 14 is a diagram illustrating a schematic configuration of a power supply system including a power feeding device according to a fifth embodiment.

FIG. 15 is a diagram illustrating, as functional blocks, components of a chopper driving controller of a power feeding device according to another embodiment.

FIG. 16 is a functional block diagram schematically illustrating components of a failure detector in which a signal generator includes one comparator.

### DESCRIPTION OF EMBODIMENTS

Embodiments of the present invention are described in detail below with reference to the drawings. The same or equivalent portions in the figures are denoted by the same reference numerals and signs and description of the portions is not repeated.

### First Embodiment

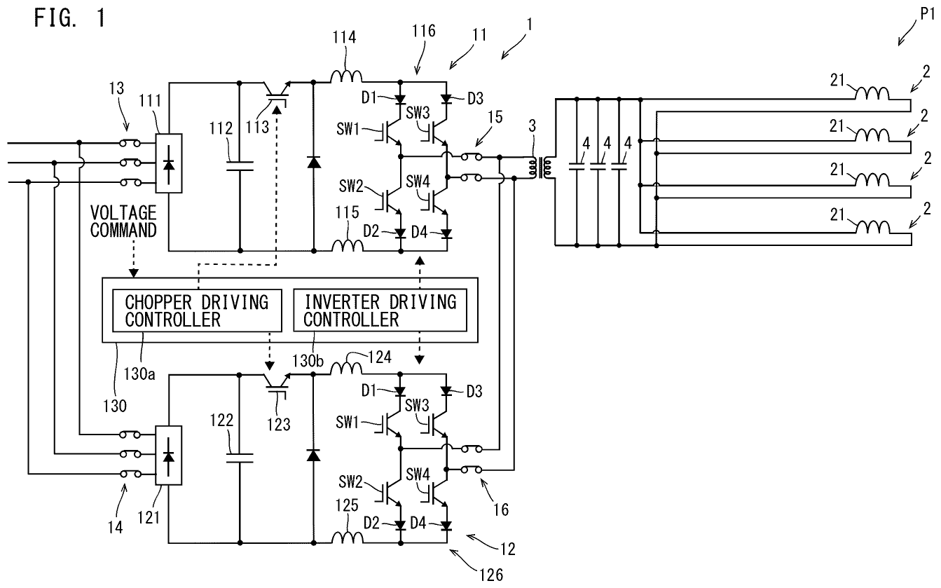

FIG. 1 is a diagram illustrating a schematic configuration of a power supply system P1 including a power feeding device 1 and a plurality of track circuits 2 according to a first embodiment of the present invention. The power feeding device 1 is a track power supply board that supplies electric power to the plurality of track circuits 2 (loads) electrically connected in parallel. The plurality of track circuits 2 are, for example, circuits that supply electric power to a mobile body that travels along a track. Electric power is supplied to the power feeding device 1 from a not-illustrated power supply.

The power supply system P1 includes a transformer 3 that supplies electric power from the power feeding device 1 to the plurality of track circuits 2, the track circuits 2, and a plurality of capacitors 4 constituting a resonance circuit. The plurality of capacitors 4 are located between the transformer 3 and the plurality of track circuits 2 and electrically connected to one another in parallel.

The plurality of track circuits 2 are electrically connected to the transformer 3 and electrically connected to one another in parallel. The plurality of track circuits 2 respectively include inherent inductances 21.

The power feeding device 1 includes a plurality of power supply circuits 11 and 12 (power converters) electrically connected in parallel. The plurality of power supply circuits 11 and 12 are electrically connected to a not-illustrated power supply. In the present embodiment, the power feeding device 1 includes two power supply circuits 11 and 12. In the present embodiment, the two power supply circuits 11 and 12 have the same configuration. Thus, in the following description, only the power supply circuit 11 is described.

The power supply circuit 11 includes a rectifier circuit 111, a capacitor 112, a switching element for chopper 113, an inductor 114, an inductor 115, a current-type inverter 116, and a driving controller 130.

The not-illustrated power supply is electrically connected to an input side of the power supply circuit 11. The power feeding device 1 includes a circuit breaker 13 between the power supply circuit 11 and the power supply. The circuit breaker 13 is, for example, three-phase three-line type.

The transformer 3 is electrically connected to an output side of the power supply circuit 11. The power feeding device 1 includes a circuit breaker 15 between the power supply circuit 11 and the transformer 3. The circuit breaker 15 is, for example, a single-phase two-line type.

The rectifier circuit 111 is located on the input side of the power supply circuit 11 and electrically connected to the not-illustrated power supply. The rectifier circuit 111 is electrically connected to the power supply by a three-phase wire. The rectifier circuit 111 includes, for example, a plurality of diodes constituting a full-wave rectifier circuit. Note that the diodes of the rectifier circuit 111 may constitute a half-wave rectifier circuit. A three-phase AC current supplied from the power supply is rectified by the rectifier circuit 111.

The capacitor 112 is electrically connected to the rectifier circuit 111 in parallel. An electric current rectified by the rectifier circuit 111 can be smoothed by the capacitor 112.

The switching element for chopper 113 is located between the capacitor 112 and the inductor 114. The switching element for chopper 113 controls an electric current supplied to the inductor 114. That is, when the switching element for chopper 113 is in an ON state, the electric current flows from the capacitor 112 to the inductor 114 and, on the other hand, when the switching element for chopper 113 is in an OFF state, the electric current does not flow from the capacitor 112 to the inductor 114.

The switching element for chopper 113 may be an IGBT, may be a power semiconductor device having another configuration, or may be a switching element having another configuration if it has a configuration capable of interrupting the flow of the electric current.

The inductor 114 is located between the switching element for chopper 113 and the current-type inverter 116. The inductor 114 supplies a constant current to the current-type inverter 116.

The current-type inverter 116 converts a DC current supplied from the inductor 114 into an AC current having a predetermined frequency and outputs the AC current to the transformer 3. The current-type inverter 116 includes four switching elements SW1 to SW4 and four diodes D1 to D4. The switching elements and the diodes are electrically connected in series. The switching elements SW1 and SW2 are electrically connected in series. The switching elements SW3 and SW4 are electrically connected in series. The switching elements SW1 and SW2 electrically connected in series and the switching elements SW3 and SW4 electrically connected in series constitute a bridge circuit. That is, a middle point between the switching elements SW1 and SW2 is electrically connected to one terminal on a primary side of the transformer 3. A middle point between the switching elements SW3 and SW4 is electrically connected to the other terminal on the primary side of the transformer 3.

Note that the diodes D1 and D3 are located on an input side of the current-type inverter 116 with respect to the switching elements SW1 and SW3. The diodes D2 and D4 are located on an output side of the current-type inverter 116 with respect to the switching elements SW2 and SW4.

The switching elements SW1 to SW4 may be IGBTs or may be power semiconductor devices having another configuration.

In the following description, in the power supply circuit 12, a rectifier circuit is denoted by a reference numeral 121, a capacitor is denoted by a reference number 122, a switching element for chopper is denoted by a reference numeral 123, an inductor is denoted by a reference numeral 124, an inductor is denoted by a reference numeral 125, and a current-type inverter is denoted by a reference numeral 126. Note that the power feeding device 1 includes, between the power supply circuit 12 and the power supply, a circuit breaker 14 that is the same as the circuit breaker 13. The power feeding device 1 includes, between the power supply circuit 12 and the power supply, a circuit breaker 16 that is the same as the circuit breaker 15.

The driving controller 130 controls driving of the current-type inverter 116 and the switching element for chopper 113. Specifically, the driving controller 130 includes a chopper driving controller 130a and an inverter driving controller 130b.

The chopper driving controller 130a controls driving of the switching elements for chopper 113 and 123 based on a voltage command and a current value of the power feeding device 1. The power supply to the inductor 114 is controlled by the control of the driving of the switching element for chopper 113 by the chopper driving controller 130a. Accordingly, supply of a voltage and an electric current to the plurality of track circuits 2 is controlled. Similarly, the power supply to the inductor 124 is controlled by the control of the driving of the switching element for chopper 123 by the chopper driving controller 130a. Accordingly, supply of a voltage and an electric current to the plurality of track circuits 2 is controlled.

The inverter driving controller 130b controls the driving of the switching elements SW1 to SW4 of the current-type inverters 116 and 126. The inverter driving controller 130b controls the driving of the switching elements SW1 to SW4 of the current-type inverter 116 such that an AC current having a predetermined frequency is output from the power supply circuit 11. Similarly, the inverter driving controller 130b controls the driving of the switching elements SW1 to SW4 of the current-type inverter 126 such that an AC current having a predetermined frequency is output from the power supply circuit 12.

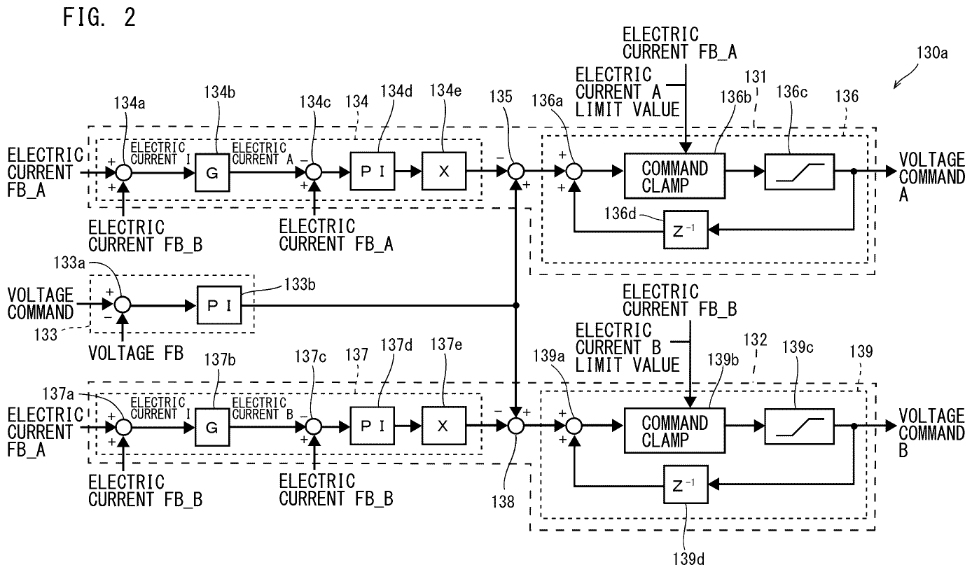

FIG. 2 is a diagram illustrating, as functional blocks, components of the chopper driving controller 130a. As illustrated in FIG. 2, the chopper driving controller 130a includes a first command generator 131, a second command generator 132, and a voltage corrector 133.

The first command generator 131 generates a voltage command A to the switching element for chopper 113 based on an electric current flowing through the power supply circuit 11 and a correction value obtained by the voltage corrector 133. The second command generator 132 generates a voltage command B to the switching element for chopper 123 based on an electric current flowing through the power supply circuit 12 and the correction value obtained by the voltage corrector 133. The voltage corrector 133 calculates, as the correction value, the difference between a voltage command input to the driving controller 130 and a voltage on the primary side of the transformer 3.

The first command generator 131 and the second command generator 132 are respectively capable of changing, according to the voltage command input to the driving controller 130, voltage commands to be generated. The first command generator 131 and the second command generator 132 generate the voltage command A and the voltage command B different from each other to match the voltage on the primary side of the transformer 3 to the voltage command input to the driving controller 130. Note that the first command generator 131 and the second command generator 132 may generate the same voltage command to match the voltage on the primary side of the transformer 3 to the voltage command input to the driving controller 130.

The first command generator 131 includes a current corrector 134, a voltage command corrector 135, and a voltage command generator 136. The first command generator 131 adjusts, with the current corrector 134, a current output of the power supply circuit 11 with a gain such that a ratio of the current output to a current value of the power feeding device 1 is a desired ratio and calculates a deviation of an electric current in the power supply circuit 11 and generates, with the voltage command generator 136, the voltage command A to the power supply circuit 11 considering a correction value obtained by the voltage corrector 133 for a value of the deviation.

The current corrector 134 includes a current adder 134a, a reference current calculator 134b, a current deviation calculator 134c, a PI controller 134d, and a current correction adjuster 134e.

The current adder 134a adds up electric currents (an electric current FB_A and an electric current FB_B) flowing through the power supply circuits 11 and 12 and calculates an electric current (an electric current I) flowing from the power feeding device 1 to the primary side of the transformer 3. The reference current calculator 134b calculates a reference value (an electric current A) of the electric current flowing through the power supply circuit 11. The current deviation calculator 134c calculates, as a deviation of the electric current A, the difference between the reference value (the electric current A) of the electric current flowing through the power supply circuit 11 and the electric current (the electric current FB_A) actually flowing through the power supply circuit 11.

The PI controller 134d adjusts the deviation of the electric current A with a gain and converts the adjusted deviation of the electric current A into a signal indicating a target value (a correction value) of the electric current A. The current correction adjuster 134e converts the target value of the electric current A into a voltage command equivalent to the target value of the current A.

The voltage command corrector 135 calculates, as a voltage control amount, the difference between the correction value of the voltage obtained by the voltage corrector 133 and the voltage command equivalent to the target value of the electric current A.

The voltage command generator 136 generates, using the voltage control amount obtained by the voltage command corrector 135, the voltage command A to the switching element for chopper 113 of the power supply circuit 11 not to exceed a limit value. Specifically, the voltage command generator 136 includes a voltage command adder 136a, a current limiter 136b, a current limiter section 136c, and an integrator 136d.

The voltage command adder 136a adds a previous voltage command integral-compensated by the integrator 136d to the voltage control amount obtained by the voltage command corrector 135 and outputs the voltage command A. The current limiter 136b limits the voltage command A with a predetermined value such that an electric current more than expected does not flow. The predetermined value is determined by the electric current (the electric current FB_A) flowing through the power supply circuit 11 and a limit value for an electric current (for example, a percentage obtained by considering a calculation error of the first command generator 131, a safety factor of the power supply system P1, and the like). The current limiter section 136c sets an upper limit for the voltage command A to, when the switching element for chopper 113 is driven by the voltage command A to supply an electric current to the power supply circuit 11, stop the driving of the current-type inverter 116 when an electric current more than expected flows to the power supply circuit 11. The integrator 136d integral-compensates the voltage command A output from the current limiter section 136c.

The voltage command A output from the current limiter section 136c is input to the switching element for chopper 113 of the power supply circuit 11.

The second command generator 132 includes a current corrector 137, a voltage command corrector 138, and a voltage command generator 139. The second command generator 132 is the same as the configuration of the first command generator 131 except that the current corrector 137 adjusts a current output of the power supply circuit 12 with a gain such that a ratio of the current output to a current value of the power feeding device 1 is a desired ratio and calculates a reference value (an electric current B) of an electric current flowing through the power supply circuit 12 and a deviation of the electric current B, the voltage command corrector 138 uses a voltage command equivalent to a target value (a correction value) of the electric current B, and the voltage command generator 139 generates a voltage command B to the power supply circuit 12. Thus, detailed description about the configuration of the second command generator 132 is omitted.

Note that the current corrector 137 includes a current adder 137a, a reference current calculator 137b, a current deviation calculator 137c, a PI controller 137d, and a current correction adjuster 137e. The voltage command generator 139 includes a voltage command adder 139a, a current limiter 139b, a current limiter section 139c, and an integrator 139d.

The voltage corrector 133 calculates, as a voltage deviation, the difference between the voltage command input to the driving controller 130 and the voltage on the primary side of the transformer 3 and converts the voltage deviation into a signal indicating a target value with PI control. The voltage corrector 133 includes a voltage deviation calculator 133a and a PI controller 133b.

The voltage deviation calculator 133a calculates, as a voltage deviation, the difference between the voltage command input to the driving controller 130 and a voltage (a voltage FB) on the primary side of the transformer 3. The PI controller 133b adjusts the voltage deviation with a gain and converts the adjusted voltage deviation into a signal indicating a target value of a voltage. The converted target value of the voltage is input to the voltage command corrector 135 of the first command generator 131 and the voltage command corrector 138 of the second command generator 132.

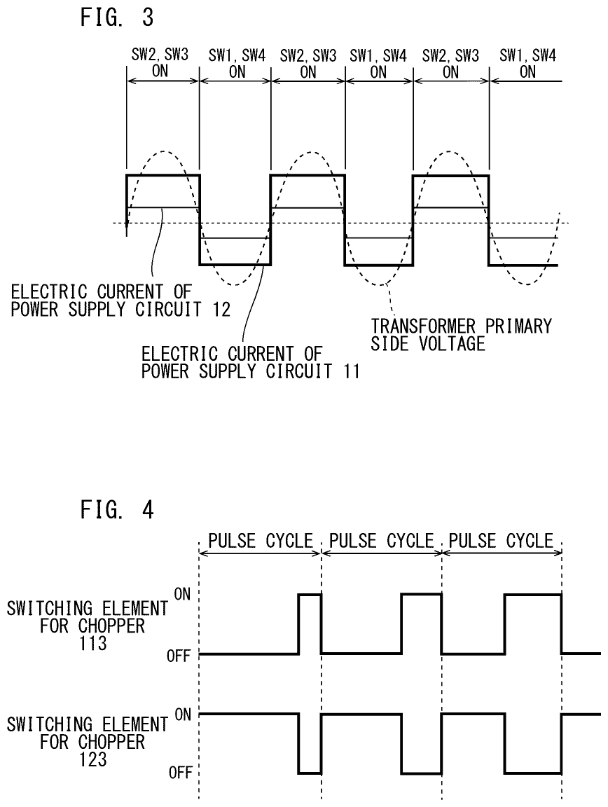

Since the driving controller 130 has the configuration described above, it is possible to adjust electric currents output from the two power supply circuits 11 and 12 and supply predetermined electric power to the track circuits 2 via the transformer 3. FIG. 3 is a diagram illustrating a relation between output currents of the power supply circuits 11 and 12 and the voltage on the primary side of the transformer 3. As illustrated in FIG. 3, the driving controller 130 having the configuration described above causes the power supply circuits 11 and 12 to output different currents such that the voltage on the primary side of the transformer 3 reaches a desired voltage.

As described above, since the power feeding device 1 has the configuration in which electric power can be supplied from the two power supply circuits 11 and 12 to the track circuits 2, even when the switching elements of one power supply circuit of the two power supply circuits 11 and 12 have failed, electric power can be supplied to the track circuits 2 from the other power supply circuit. Therefore, it is possible to implement the power feeding device 1 capable of continuously feeding electric power to the track circuits 2.

In the present embodiment, the power feeding device 1 supplies electric power to the track circuits 2. The power feeding device 1 includes the plurality of power supply circuits 11 and 12 that include the pluralities of switching elements SW1 to SW4, are electrically connected to the power supply and the track circuits 2, and are electrically connected to each other in parallel, as well as the driving controller 130 that controls the driving of the pluralities of switching elements SW1 to SW4 to thereby control supply of electric power to the track circuits 2 by the plurality of power supply circuits 11 and 12.

Accordingly, by driving the pluralities of switching elements SW1 to SW4 in the plurality of power supply circuits 11 and 12 electrically connected to each other in parallel, electric power can be supplied from the plurality of power supply circuits 11 and 12 to the track circuits 2. Thus, even when the switching element has failed in a subset of the plurality of power supply circuits 11 and 12, by driving the plurality of switching elements SW1 to SW4 in the other power supply circuit with the driving controller 130, electric power can be supplied from the other power supply circuit to the track circuits 2.

Therefore, even when the switching elements SW1 to SW4 have failed in a subset of the plurality of power supply circuits 11 and 12, electric power can be continuously supplied from the power feeding device 1 to the track circuits 2.

The driving controller 130 may control driving of the switching elements for chopper 113 and 123 in the plurality of power supply circuits 11 and 12 respectively such that electric currents output from the plurality of power supply circuits 11 and 12 are different for each of the power supply circuits. That is, the driving controller 130 may generate the voltage command A and the voltage command B and output the voltage command A and the voltage command B to the plurality of power supply circuits 11 and 12 such that the electric currents output from the plurality of power supply circuits 11 and 12 are different for each of the power supply circuits.

Accordingly, different electric currents can be output from the plurality of power supply circuits 11 and 12. Thus, degrees of deterioration of the switching elements for chopper 113 and 123 and the pluralities of switching elements SW1 to SW4 in the respective power supply circuits can be made different. Therefore, occurrence timing of failure of the switching elements can be changed in the plurality of power supply circuits 11 and 12.

Thus, the switching elements for chopper 113 and 123 or the switching elements SW1 to SW4 of the power supply circuits can be prevented from simultaneously failing. Therefore, even when the switching element in a subset of the plurality of power supply circuits 11 and 12 has failed, electric power can be continuously supplied from the power feeding device 1 to the track circuits 2.

For example, the driving controller 130 may generate the voltage command A and the voltage command B and output the voltage command A and the voltage command B to the two power supply circuits 11 and 12 such that, at the normal time, a current output of one of the two power supply circuits 11 and 12 is 100% and a current output of the other is 0%. When the switching elements have failed in the one power supply circuit, the driving controller 130 may generate the voltage command A and the voltage command B and output the voltage command A and the voltage command B to the two power supply circuits 11 and 12 such that the current output of the one power supply circuit is 0% and the current output of the other power supply circuit is 100%.

For example, the driving controller 130 may generate the voltage command A and the voltage command B and output the voltage command A and the voltage command B to the two power supply circuits 11 and 12 such that, at the normal time, the current outputs of the two power supply circuits 11 and 12 are 50% each. When the switching elements have failed in the one power supply circuit, the driving controller 130 may generate the voltage command A and the voltage command B and output the voltage command A and the voltage command B to the two power supply circuits 11 and 12 such that the current output of the one power supply circuit is 0% and the current output of the other power supply circuit is 100%.

As described above, when the switching element in a subset of the plurality of power supply circuits 11 and 12 has failed, the driving controller 130 may control driving of the plurality of switching elements in the power supply circuit not in failure to control an electric current output from the power supply circuit not in failure.

Accordingly, when the switching element in a subset of the plurality of power supply circuits 11 and 12 has failed, electric power can be supplied from the power supply circuit not in failure to a load by driving the plurality of switching elements of the power supply circuit not in failure.

Therefore, even when the switching element in a subset of the plurality of power supply circuits has failed, electric power can be continuously supplied from the power feeding device 1 to the track circuits 2.

For example, the driving controller 130 may generate the voltage command A and the voltage command B and output the voltage command A and the voltage command B to the two power supply circuits 11 and 12 such that a ratio of the current outputs of the two power supply circuits 11 and 12 is changed.

The driving controller 130 may periodically change the ratio of the current outputs, for example, the driving controller 130 generates the voltage command A and the voltage command B and outputs the voltage command A and the voltage command B to the two power supply circuits 11 and 12 such that the current output of one of the two power supply circuits 11 and 12 is 30% and the current output of the other is 70% and, when a predetermined period has elapsed, generates the voltage command A and the voltage command B and outputs the voltage command A and the voltage command B to the two power supply circuits 11 and 12 such that the current output of the one of the two power supply circuits 11 and 12 is 70% and the current output of the other is 30%.

Accordingly, compared with when the ratio of the current outputs output from the plurality of power supply circuits 11 and 12 is fixed, an average value and an effective value of electric currents can be suppressed as a whole. Thus, a degree of deterioration of the pluralities of switching elements SW1 to SW4 in the respective power supply circuits can be delayed. Therefore, occurrence timing of failure of the switching elements for chopper 113 and 123 and the switching elements SW1 to SW4 can be delayed in the plurality of power supply circuits 11 and 12.

For example, the driving controller 130 may detect the temperature of the switching elements for chopper 113 and 123 or the switching elements SW1 to SW4 in the two power supply circuits 11 and 12, and generate the voltage command A and the voltage command B and output the voltage command A and the voltage command B to the two power supply circuits 11 and 12 such that the ratio of the current outputs of the two power supply circuits 11 and 12 is changed according to a result of the detection. That is, for example, when the temperature of the switching element for chopper 113 or the switching elements SW1 to SW4 of the power supply circuit 11 exceeds a threshold, the driving controller 130 may generate the voltage command A and output the voltage command A to the power supply circuit 11 to reduce the current output of the power supply circuit 11. In this case, the driving controller 130 generates the voltage command B and outputs the voltage command B to the power supply circuit 12 to increase the current output of the power supply circuit 12. Depending on the temperature of the switching element for chopper 113 or the switching elements SW1 to SW4 of the power supply circuit 11, the driving controller 130 may generate the voltage command A and the voltage command B and output the voltage command A and the voltage command B to the two power supply circuits 11 and 12 such that the current output of the power supply circuit 11 is 0% and the current output of the power supply circuit 12 is 100%.

Note that, when generating the voltage command A and the voltage command B so as to cause the current outputs of the two power supply circuits 11 and 12 to differ from each other or to change as described above, the driving controller 130 adjusts a gain such that a ratio of the current outputs of the two power supply circuits 11 and 12 is a desired ratio in the reference current calculators 134b and 137b.

By changing the ratio of the current outputs of the two power supply circuits 11 and 12 with the driving controller 130 as described above, deterioration of the switching elements for chopper 113 and 123 and the switching elements SW1 to SW4 of the power supply circuits 11 and 12 can be delayed. Thus, timing of failure of the switching elements for chopper 113 and 123 and the switching elements SW1 to SW4 of the power supply circuits 11 and 12 can be adjusted. Therefore, electric power can be securely continuously supplied from the power feeding device 1 to the track circuits 2.

### Modifications

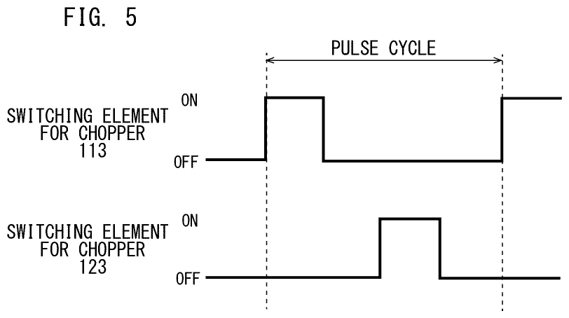

In the power feeding device 1 having the configuration described above, the chopper driving controller 130a may generate a command signal such that, with respect to command signals for driving the switching elements for chopper 113 and 123 of the two power supply circuits 11 and 12, periods of the ON state in pulse cycles of the command signals do not overlap. For example, when a period of the ON state or a period of the OFF state of the pulse cycles of the command signals exceeds a period of a half of a control cycle of the chopper driving controller 130a as illustrated in FIG. 4, the chopper driving controller 130a only has to generate a command signal such that the period of the ON state and the period of the OFF state of the command signal for driving the switching elements for chopper 113 and 123 are reversed. When the period of the ON state or the period of the OFF state of the pulse cycles of the command signals does not exceed the period of the half of the control cycle as illustrated in FIG. 5, the chopper driving controller 130a only has to generate a command signal such that a period of the ON state of the switching element for chopper having a short period of ON state is included in the period of the OFF state of the switching element for chopper having a long period of the ON state.

Accordingly, timing when an electric current is supplied to the inductor 114 of the power supply circuit 11 and timing when an electric current is supplied to the inductor 124 of the power supply circuit 12 can be shifted. Thus, ripple components included in electric currents output from the power supply circuits 11 and 12 can be reduced.

### Second Embodiment

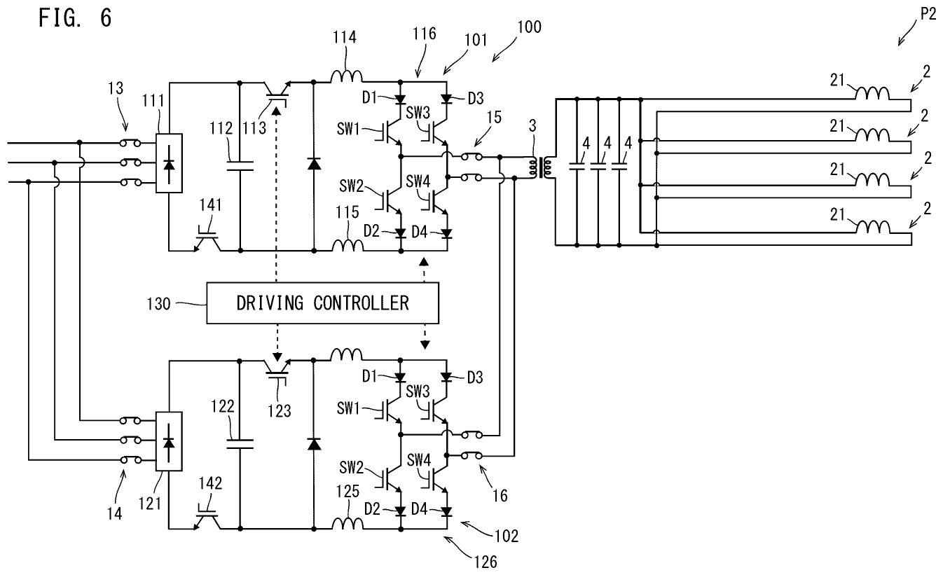

FIG. 6 is a diagram illustrating a schematic configuration of a power supply system P2 including a power feeding device 100 according to a second embodiment. The power feeding device 100 in the present embodiment is different from the power feeding device 1 in the first embodiment in that power supply circuits 101 and 102 include switching elements for current interruption 141 and 142 further on a power supply side than the current-type inverters 116 and 126 and further on the power supply side than the capacitors 112 and 122. In the following description, the same components as the components in the first embodiment are denoted by the same reference numerals and signs and description of the components is omitted and only differences from the first embodiment are described.

The switching elements for current interruption 141 and 142 (current breakers) are located further on the power supply side than the current-type inverters 116 and 126 and further on the power supply side than the capacitors 112 and 122. Specifically, the switching elements for current interruption 141 and 142 are located between the rectifier circuits 111 and 121 and the capacitor 112 and 122 and on a low voltage side.

The switching elements for current interruption 141 and 142 may be IGBTs, may be power semiconductor devices having another configuration, or may be switching elements having another configuration if the switching elements have a configuration capable of interrupting a flow of an electric current.

The switching elements for current interruption 141 and 142 may be drive-controlled by the driving controller 130 or may be drive-controlled by a dedicated controller. The switching elements for current interruption 141 and 142 may be drive-controlled when the switching elements of one power supply circuit of the two power supply circuits 101 and 102 have failed or may be drive-controlled when an electric current flowing through the switching elements for current interruption 141 and 142 is equal to or more than a threshold.

For example, when the switching elements of one power supply circuit of the two power supply circuits 101 and 102 have failed, an electric current is likely to flow from the other power supply circuit to a current-type inverter of the one power supply circuit. The electric current flowing into the current-type inverter of the one power supply circuit is likely to flow toward the power supply on the low voltage side in the one power supply circuit. By providing the switching elements for current interruption 141 and 142 in the power supply circuits as described above, the return currents described above can be stopped.

Moreover, by turning the switching elements for current interruption 141 and 142 to the OFF state at the start time of the power feeding device 100, an inrush current can be prevented from flowing into the capacitors 112 and 122.

From the above, in the present embodiment, the power supply circuits 101 and 102 include the current-type inverters 116 and 126 (switching circuits) configured by the pluralities of switching elements SW1 to SW4, the capacitors 112 and 122 provided further on the power supply side than the current-type inverters 116 and 126 and electrically connected to the power supply in parallel, and the switching elements for current interruption 141 and 142 provided further on the power supply side than the capacitors 112 and 122 and capable of, when the switching element in a subset of the plurality of power supply circuits 101 and 102 has failed, interrupting a return current flowing from the current-type inverter side to the power supply side in the subset of power supply circuits.

Accordingly, the switching element in a subset of the plurality of power supply circuits 101 and 102 has failed and the current-type inverter falls into a short circuit state, a return current flowing from the remaining power supply circuit to the power supply side via the current-type inverter of the subset of power supply circuits can be interrupted by the switching elements for current interruption 141 and 142.

Thus, even when the switching element in a subset of the plurality of power supply circuits 101 and 102 electrically connected in parallel has failed, the power supply side of the power feeding device 100 can be prevented from being damaged.

Moreover, since the switching elements for current interruption 141 and 142 are located further on the power supply side than the capacitors 112 and 122 located on the power supply side with respect to the current-type inverters 116 and 126, at the start time of the power feeding device 100, an electric current can be interrupted by the switching elements for current interruption 141 and 142 and an inrush current can be prevented from flowing into the capacitors 112 and 122.

### Third Embodiment

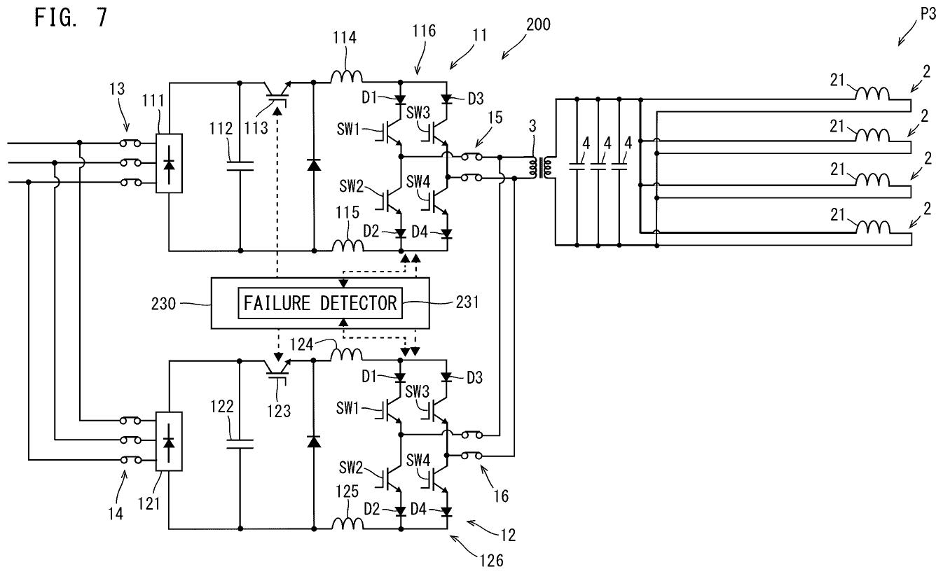

FIG. 7 is a diagram illustrating a schematic configuration of a power supply system P3 including a power feeding device 200 according to a third embodiment.

The power feeding device 200 in the present embodiment is different from the power feeding device 1 in the first embodiment in that a driving controller 230 includes a failure detector 231 that performs failure detection for the current-type inverters 116 and 126 of the power supply circuits 11 and 12. In the following description, the same components as the components in the first embodiment are denoted by the same reference numerals and signs and description of the components is omitted and only differences from the first embodiment are described.

As illustrated in FIG. 7, the driving controller 230 includes the failure detector 231 that performs the failure detection for the current-type inverters 116 and 126 of the power supply circuits 11 and 12.

The failure detector 231 detects presence or absence of failure in the switching elements for chopper 113 and 123 and the switching elements SW1 to SW4 of the current-type inverters 116 and 126 based on a driving signal such as a gate signal and output signals (signals that can be input to comparators and the like described below) of the switching elements.

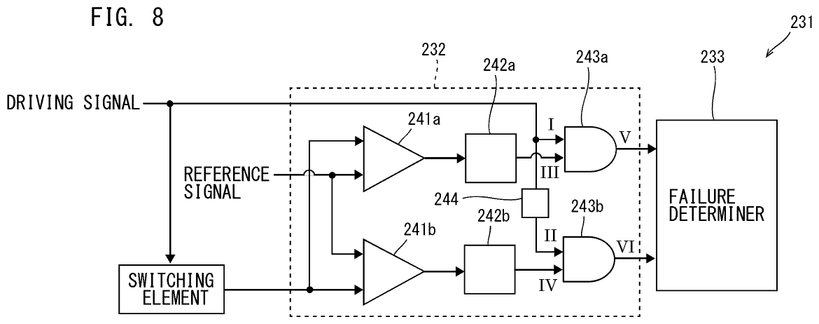

FIG. 8 is a functional block diagram schematically illustrating components of the failure detector 231. As illustrated in FIG. 8, the failure detector 231 includes a signal generator 232 and a failure determiner 233. The signal generator 232 generates, using the driving signal and the output signal, a determination signal for determining failure of the switching elements.

The signal generator 232 includes comparators 241a and 241b, signal converters 242a and 242b, and logic circuits 243a and 243b. In the present embodiment, the signal generator 232 includes two comparators, two signal converters, and two logic circuits.

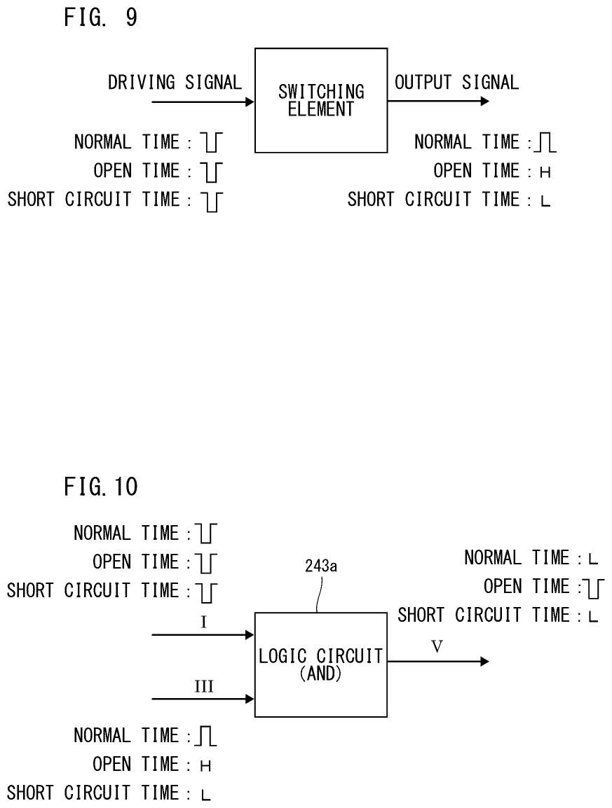

The comparators 241a and 241b generate a comparison signal using an output signal of a switching element and a reference signal. The output signal is, for example, a signal illustrated in FIG. 9. When a driving signal illustrated in FIG. 9 is input to the switching element, an output signal in a state in which High and Low are inverted with respect to the driving signal is obtained when the switching element is normal (a normal time). On the other hand, when the switching element is in an open state (an open time), a High signal (H) is output from the switching element. When the switching element is in a short circuit state (a short circuit time), a Low signal (L) is output from the switching element. The reference signal is, for example, a constant signal having a value between the High signal and the Low signal in the output signal of the switching element.

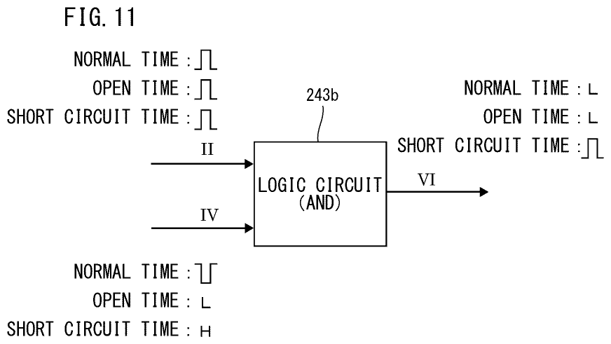

The signal converters 242a and 242b convert comparison signals respectively output from the comparators 241a and 241b and generate signals indicated by III in FIG. 10 and IV in FIG. 11. In the present embodiment, the signal converter 242a outputs the signal indicated by III in FIG. 10. The signal converter 242b outputs the signal indicated by IV in FIG. 11. Note that the signal indicated by III in FIG. 10 is a signal having the same waveform as a waveform of the output signal of the switching element. The signal indicated by IV in FIG. 11 is a signal in a state in which High and Low are inverted with respect to the output signal.

The logic circuits 243a and 243b generate determination signals V and VI based on the signals output from the signal converters 242a and 242b and the driving signal. Specifically, the logic circuit 243a performs an AND logic operation using the signal output from the signal converter 242a (the signal indicated by III in FIG. 10) and the driving signal (a signal indicated by I in FIG. 10). When the signals indicated by I and III in FIG. 10 are input to the logic circuit 243a, at the normal time of the switching element, the Low signal is output from the logic circuit 243a, at the open time of the switching element, the signal having the same waveform as the waveform of the driving signal is output, and at the short circuit time of the switching element, the Low signal is output.

The logic circuit 243b performs the AND logic operation using the signal output from the signal converter 242b (the signal indicated by IV in FIG. 11) and a signal in the state in which High and Low are inverted with respect to the driving signal (a signal indicated by II in FIG. 11) by a logic circuit 244 (a NOT circuit) or the like. When the signals indicated by II and IV in FIG. 11 are input to the logic circuit 243b, at the normal time of the switching element, the Low signal is output from the logic circuit 243a, at the open time of the switching element, the Low signal is output, and at the short circuit time of the switching element, a signal having the same waveform as the waveform of the signal indicated by II is output.

The determination signals V and VI obtained as described above are input to the failure determiner 233. The failure determiner 233 determines failure of the switching element based on the determination signals V and VI. Specifically, when a signal having a waveform other than the Low signal is input, the failure determiner 233 determines that the switching element is in failure. When the determination signal V having a waveform other than the Low signal is input, the failure determiner 233 determines that the switching element is in the open state. When the determination signal VI having a waveform other than the Low signal is input, the failure determiner 233 determines that the switching element is in the short circuit state. That is, the failure determiner 233 can determine the normal state, the open state, and the short circuit state in the switching element.

Note that, although not particularly illustrated, like the driving controller 130 in the first embodiment, the driving controller 230 in the present embodiment includes an inverter driving controller that drive-controls the switching elements SW1 to SW4 of the current-type inverters 216 and 226 and a chopper driving controller that drive-controls the switching elements for chopper 113 and 123.

With the configuration of the present embodiment, failure of the switching elements for chopper 113 and 123 and the switching elements SW1 to SW4 of the current-type inverters 116 and 126 of the power supply circuits 11 and 12 can be detected. Moreover, failure of opening and short circuit of the switching elements for chopper 113 and 123 and the switching elements SW1 to SW4 can also be detected.

When the open state and the short circuit state of the switching element are detected by different detection devices, a difference occurs in detection timing. Then, measures taken at the failure time are likely to be delayed. In contrast, since the states (normal, open, and short circuit) of the switching element can be simultaneously determined by the configuration of the present embodiment, failure of the switching element can be quickly detected.

Note that, in the present embodiment, the failure detector 231 is a part of functions of the driving controller 230. However, the failure detector may be configured by a controller different from the driving controller 230. The failure detector 231 may have a configuration other than the configuration in the present embodiment if the configuration is capable of simultaneously detecting the states (normal, open, and short circuit) of the switching element.

### Fourth Embodiment

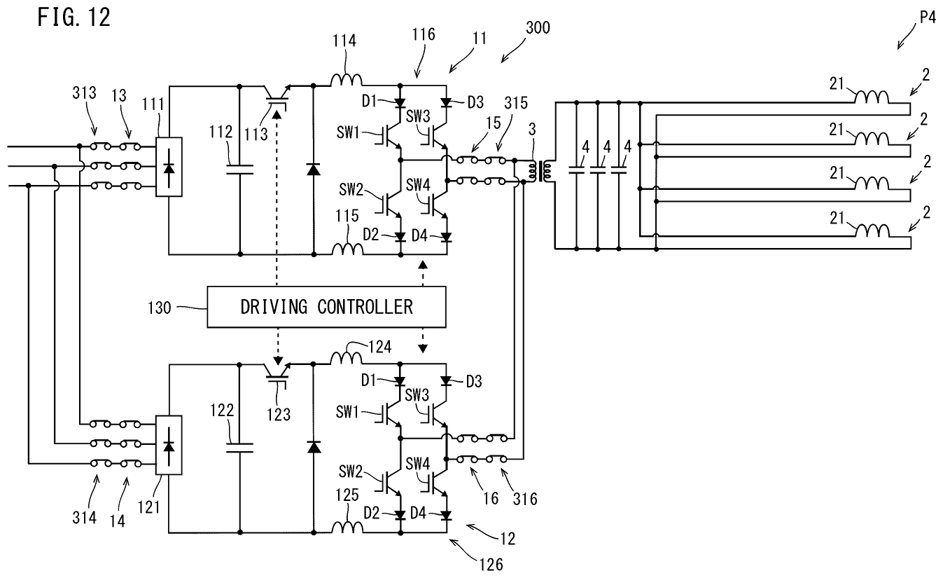

FIG. 12 is a diagram illustrating a schematic configuration of a power supply system P4 including a power feeding device 300 according to a fourth embodiment. The power feeding device 300 in the present embodiment is different from the power feeding device 1 in the first embodiment in that the power feeding device 300 includes breakers 313, 314, 315, and 316 respectively on a power supply side and the transformer 3 side of the power supply circuits 11 and 12. In the following description, the same components as the components in the first embodiment are denoted by the same reference numerals and signs and description of the components is omitted and only differences from the first embodiment are described.

As illustrated in FIG. 12, the power feeding device 300 includes the breakers 313, 314, 315, and 316 respectively on the power supply side and the transformer 3 side of the power supply circuits 11 and 12. The breakers 313, 314, 315, and 316 mechanically disconnect the circuits according to switch operation. The breakers 313 and 314 are located further on the power supply side than the circuit breakers 13 and 14. The breakers 315 and 316 are located further on the transformer 3 side than the circuit breakers 15 and 16.

Accordingly, when the switching element of one of the current-type inverters 116 and 126 of the power supply circuits 11 and 12 has failed, the power supply circuit in failure can be securely cut off from the power supply and the transformer 3.

### Fifth Embodiment

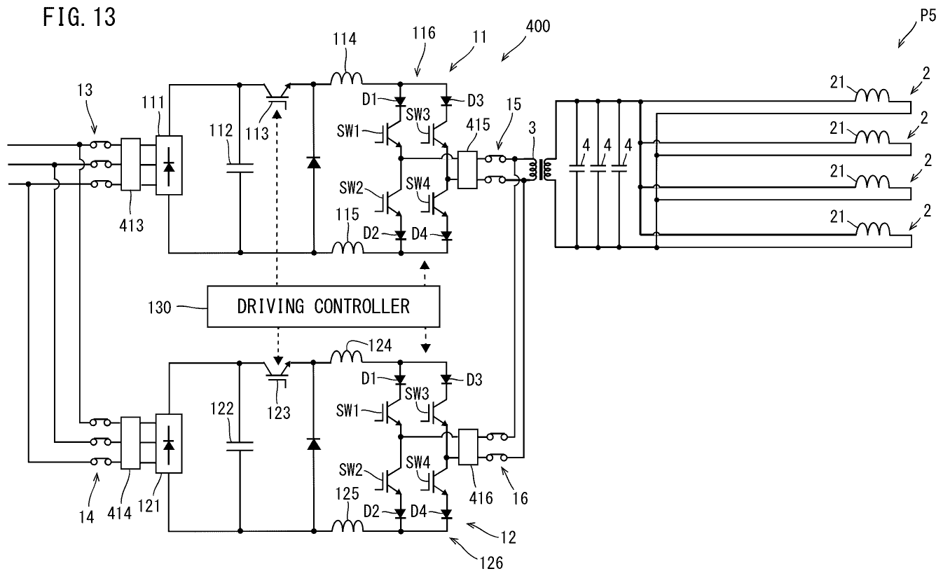

FIG. 13 is a diagram illustrating a schematic configuration of a power supply system P5 including a power feeding device 400 according to a fifth embodiment. The power feeding device 400 in the present embodiment is different from the power feeding device 1 in the first embodiment in that the power feeding device 400 includes connectors 413, 414, 415, and 416 respectively on the power supply side and the transformer 3 side of the power supply circuits 11 and 12. In the following description, the same components as the components in the first embodiment are denoted by the same reference numerals and signs and description of the components is omitted and only differences from the first embodiment are described.

As illustrated in FIG. 13, the power feeding device 400 includes the connectors 413, 414, 415, and 416 respectively on the power supply side and the transformer 3 side of the power supply circuits 11 and 12. The connectors 413, 414, 415, and 416 include not-illustrated connection terminals and can easily connect or disconnect power lines. The connectors 413 and 414 are located between the circuit breakers 13 and 14 and the power supply circuits 11 and 12. The connectors 415 and 416 are located between the circuit breakers 15 and 16 and the power supply circuits 11 and 12.

Accordingly, the power supply circuit 11 can be easily attached to and detached from the power supply and the transformer 3 by the connectors 413 and 415. Similarly, the power supply circuit 12 can be easily attached to and detached from the power supply and the transformer 3 by the connectors 414 and 416. That is, the power supply circuits 11 and 12 can be unitized.

Thus, the power supply circuit in failure of the power supply circuits 11 and 12 can be easily detached and replaced. Only one of the power supply circuits 11 and 12 can also be electrically connected to the power supply and the transformer 3 to easily change a configuration to supply electric power to the track circuits 2 with one power supply circuit.

### Sixth Embodiment

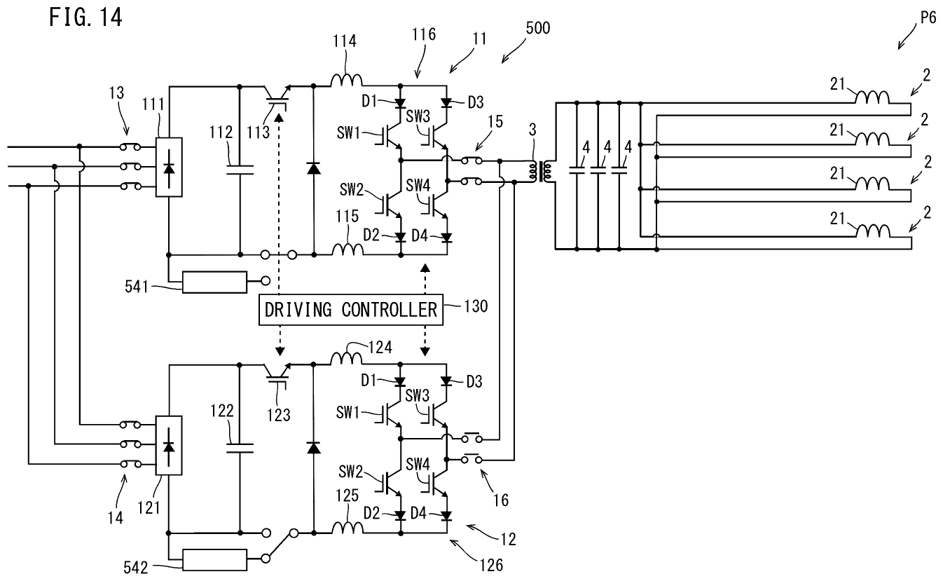

FIG. 14 is a diagram illustrating a schematic configuration of a power supply system P6 including a power feeding device 500 according to a sixth embodiment. The power feeding device 500 in the present embodiment is different from the power feeding device 1 in the first embodiment in that the power feeding device 500 includes failure part detectors 541 and 542 that detect switching elements in failure in the power supply circuits 11 and 12. In the following description, the same components as the components in the first embodiment are denoted by the same reference numerals and signs and description of the components is omitted and only differences from the first embodiment are described.

As illustrated in FIG. 14, the power feeding device 500 includes the failure part detectors 541 and 542 in the power supply circuits 11 and 12. The failure part detectors 541 and 542 are provided on a low voltage side of the power supply circuits 11 and 12 and constitute parts of the power supply circuits 11 and 12 when detecting switching elements in failure.

Specifically, as illustrated in FIG. 14, when failure detection for the switching elements SW1 to SW4 is performed in the power supply circuit 12, the failure part detector 542 constitutes a part of the low voltage side of the power supply circuit 12. Note that, as illustrated in FIG. 14, when the failure detection for the switching elements is performed in the power supply circuit 12, the circuit breaker 16 is in an open state.

On the other hand, when the failure detection for the switching elements SW1 to SW4 is not performed, as in the power supply circuit 11 illustrated in FIG. 14, the failure part detector 541 does not constitute a part of the power supply circuit 11 and is electrically separated from the power supply circuit 11.

Note that, in FIG. 14, in the power supply circuit 11, the failure part detector 541 does not perform the failure detection for the switching elements SW1 to SW4 and, in the power supply circuit 12, the failure part detector 542 performs the failure detection for the switching elements SW1 to SW4. However, in the power supply circuit 12, the failure part detector 542 may not perform the failure detection for the switching elements SW1 to SW4 and, in the power supply circuit 11, the failure part detector 541 may perform the failure detection for the switching elements SW1 to SW4. In the power supply circuits 11 and 12, the failure part detectors 541 and 542 may respectively perform the failure detection for the switching elements SW1 to SW4.

When performing the failure detection for the switching elements SW1 to SW4 of the power supply circuit 12, the failure part detector 542 outputs driving signals to the switching elements SW1 to SW4. The failure part detector 542 detects an electric current flowing in the power supply circuit 12 with driving of the switching elements SW1 to SW4. If a relation between a driving state of the switching elements SW1 to SW4 and the electric current flowing in the power supply circuit 12 is correct, the failure part detector 542 determines that failure is absent. If the relation is not a correct relation, the failure part detector 542 determines that the switching element driving at that time is in failure.

From the above, in the present embodiment, the plurality of power supply circuits 11 and 12 respectively include the failure part detectors 541 and 542 capable of detecting the switching element in failure among the plurality of switching elements.

Accordingly, when the switching element in a subset of the plurality of power supply circuits 11 and 12 has failed, it is possible to easily detect which switching element has failed in the subset of power supply circuits. Thus, the switching element in failure can be easily replaced. Therefore, even when a switching element of a power supply circuit has failed, the power supply circuit can be quickly restored.

Note that the failure part detectors 541 and 542 may detect failure of the switching elements for chopper 113 and 123. Failure part detectors may be provided only in a subset of a plurality of power supply circuits. Positions where the failure part detectors are provided in the power supply circuits are not limited to the low voltage side of the power supply circuit and may be any position if the position is a position where failure of switching elements can be detected.

### Other Embodiments

The embodiments of the present invention are described above. However, the embodiments described above are merely exemplifications for carrying out the present invention. Thus, the present invention is not limited to the embodiments described above, and the embodiments described above can be modified as appropriate and carried out within a range not departing from the gist of the present invention.

In the embodiments, the power feeding device 1 includes the two power supply circuits 11 and 12. However, a power feeding device may include three or more power supply circuits. In this case, command generators (equivalent to the first command generator 131 and the second command generator 132) may be added to a chopper driving controller according to the number of power supply circuits and a voltage command to switching elements for chopper may be generated based on an electric current flowing through the power supply circuits and a correction value obtained by a voltage corrector.

In the embodiments described above, the power feeding device 1 supplies electric power to the track circuits 2. However, the power feeding device 1 may supply electric power to a circuit other than the track circuit. That is, the configuration of the power supply system PI may be another configuration if the configuration is a configuration for supplying electric power from the power feeding device 1 to a load.

In the embodiments, the voltage command A to the power supply circuit 11 is generated by the first command generator 131. The voltage command B to the power supply circuit 12 is generated by the second command generator 132. However, a configuration that generates the voltage command A and the voltage command B is not limited to the configuration in the present embodiments. Voltage commands respectively output to a plurality of power supply circuits may be generated in any way if the plurality of power supply circuits can be driven to be capable of supplying electric power to a load.

In the embodiments, the power supply circuits 11 and 12 include the current-type inverters 116 and 126 as the power converters. However, a power converter included in a power supply circuit may have another configuration, such as a voltage-type inverter. That is, the power converter may have any configuration if the configuration includes a plurality of switching elements and is capable of converting electric power.

In the first embodiment, as illustrated in FIG. 2, the chopper driving controller 130a includes the first command generator 131, the second command generator 132, and the voltage corrector 133. The first command generator 131 and the second command generator 132 generate the voltage command A and the voltage command B using a correction value of a voltage obtained by the voltage corrector 133.

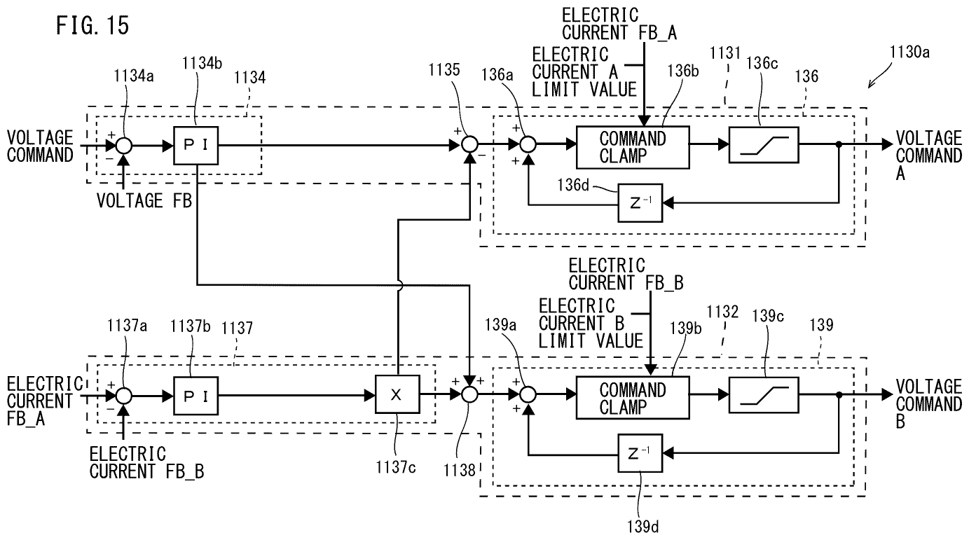

However, when driving the power supply circuits 11 and 12 with current outputs of 50% each, an inverter driving controller may generate the voltage command A and the voltage command B without using a correction value of a voltage obtained by a voltage corrector. That is, as illustrated in FIG. 15, a chopper driving controller 1130a may include a first command generator 1131 and a second command generator 1132 and, on the other hand, may not include a voltage corrector.

The first command generator 1131 includes a voltage corrector 1134, a voltage command corrector 1135, and a voltage command generator 136.

The voltage corrector 1134 includes a voltage deviation calculator 1134a and a PI controller 1134b. The voltage deviation calculator 1134a subtracts a voltage on the primary side of the transformer 3 from a voltage command to calculate a deviation of the voltage. The PI controller 1134b adjusts the calculated deviation of the voltage with a gain to convert the adjusted deviation of the voltage into a signal indicating a target value of the voltage.

The voltage command corrector 1135 subtracts a voltage command calculated by a current correction adjuster 1137c from the target value of the voltage calculated by the voltage corrector 1134 and calculates a difference between the voltage command and the target value as a voltage control amount.

Thereafter, the voltage command A is generated by the voltage command generator 136 using the voltage control amount. Note that the voltage command generator 136 has the same configuration as the configuration of the voltage command generator 136 in the first embodiment. Therefore, description of the voltage command generator 136 is omitted.

The second command generator 1132 includes a current corrector 1137, a voltage command corrector 1138, and a voltage command generator 139.

The current corrector 1137 includes a current deviation calculator 1137a, a PI controller 1137b, and the current correction adjuster 1137c.

The current deviation calculator 1137a calculates a deviation between an electric current flowing through the power supply circuit 11 and an electric current flowing through the power supply circuit 12. The PI controller 1137b adjusts the calculated deviation between the electric currents with a gain and converts the adjusted deviation into a signal indicating a target value of the electric currents. The current correction adjuster 1137c converts the target value of the electric currents into a voltage command equivalent to the target value of the electric currents. The calculated voltage command is input to the voltage command corrector 1135 of the first command generator 1131.

The voltage command corrector 1138 adds the target value of the voltages obtained by the PI controller 1134b of the first command generator 1131 to the voltage command calculated by the current correction adjuster 1137c to thereby calculate a sum of the target value and the voltage command as a voltage control amount.

Thereafter, the voltage command B is generated by the voltage command generator 139 using the voltage control amount. Note that, since the voltage command generator 139 has the same configuration as the configuration of the voltage command generator 139 in the first embodiment, description of the voltage command generator 139 is omitted.

In the second embodiment, the switching elements for current interruption 141 and 142 that stop a return current are respectively provided in the two power supply circuits 101 and 102. However, a switching element for current interruption may be provided only in one of two power supply circuits. A resistor may be provided in the power supply circuit instead of the switching element for current interruption.

In the third embodiment, the signal generator 232 includes the two comparators 241a and 241b. However, a signal generator may include only one comparator.

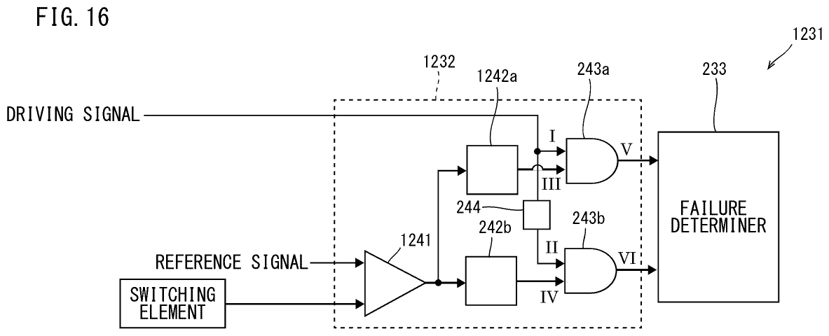

FIG. 16 is a functional block diagram schematically illustrating components of a failure detector 1231 in which a signal generator 1232 includes one comparator 1241. As illustrated in FIG. 16, the failure detector 1231 includes the signal generator 1232 and a failure determiner 233. The signal generator 1232 generates, using a driving signal and an output signal of a switching element, a determination signal for determining failure of the switching element. The comparator 1241 generates a comparison signal using the output signal of the switching element and a reference signal and outputs the comparison signal to both of signal converters 1242a and 242b. A logic circuit (a NOT circuit) or the like is incorporated in the signal converter 1242a. The signal converter 1242a can invert the comparison signal. Accordingly, a circuit configuration of the signal generator 1232 can be simplified.

In the fourth embodiment, the breakers 313, 314, 315, and 316 are respectively provided on the power supply side and the transformer 3 side of the power supply circuits 11 and 12. However, breakers may be provided only on a power supply side or a transformer side of a power supply circuit. Breakers may be provided only in a subset of a plurality of power supply circuits. Knife switches may be provided in at least one of the power supply side and the transformer side of the power supply circuit instead of the breakers.

In the fifth embodiment, the connectors 413, 414, 415, and 416 are respectively provided on the power supply side and the transformer 3 side of the power supply circuits 11 and 12. However, connectors may be provided only in a subset of a plurality of power supply circuits. That is, only a subset of the plurality of power supply circuits may be unitized.

### INDUSTRIAL APPLICABILITY

The present invention can be used in a power feeding device that supplies electric power to a load.

### REFERENCE SIGNS LIST

P1, P2, P3, P4, P5, P6 Power supply system
1, 100, 200, 300, 400, 500 Power feeding device
2 Track circuit (Load)
3 Transformer
4 Capacitor
11, 12, 101, 102 Power supply circuit (Power converter)
111, 121 Rectifier circuit
112, 122 Capacitor
113, 123 Switching element for chopper
114, 115, 124, 125 Inductor
116, 126 Current-type inverter (Switching circuit)
13, 14, 15, 16 Circuit breaker
130, 230 Driving controller
130a, 1130a Chopper driving controller
130b Inverter driving controller
131, 1131 First command generator
132, 1132 Second command generator
133 Voltage corrector
133a, 1134a Voltage deviation calculator
133b, 1134b, 1137b PI controller
134, 137, 1137 Current corrector
1134 Voltage corrector
134a, 137a Current adder
134b, 137b Reference current calculator
134c, 137c, 1137a Current deviation calculator
134d, 137d, 1134b, 1137b PI controller
134e, 137e, 1137c Current correction adjuster
135, 138, 1135, 1138 Voltage command corrector
136, 139 Voltage command generator
136a, 139a Voltage command adder
136b, 139b Current limiter
136c, 139c Current limiter section
136d, 139d Integrator
141, 142 Switching element for current interruption (Current breaker)
21 Inductance
231, 1231 Failure detector
232, 1232 Signal generator
233 Failure determiner
241a, 241b, 1241 Comparator
242a, 242b, 1242a Signal converter
243a, 243b Logic circuit
313, 314, 315, 316 Breaker
413, 414, 415, 416 Connector
541, 542 Failure part detector
SW1, SW2, SW3, SW4 Switching element
D1, D2, D3, D4 Diode

1. A power feeding device that supplies electric power to a load, the power feeding device comprising:
a plurality of power converters including pluralities of switching elements and electrically connected to a power supply and the load and electrically connected to one another in parallel; and
a driving controller that controls driving of the pluralities of switching elements to thereby control supply of electric power to the load by the plurality of power converters.

2. The power feeding device according to claim 1, wherein the driving controller controls driving of the pluralities of switching elements in the plurality of power converters respectively such that electric currents output from the plurality of power converters are different for each of the power converters.

3. The power feeding device according to claim 2, wherein, when the switching element in a subset of the plurality of power converters has failed, the driving controller controls driving of the pluralities of switching elements in the power converters not in failure to control electric currents output from the power converters not in failure.

4. The power feeding device according to claim 1, wherein each of the plurality of power converters includes:
a switching circuit configured by the plurality of switching elements;
a capacitor provided further on the power supply side than the switching circuit and electrically connected to the power supply in parallel; and
a current breaker provided further on the power supply side than the capacitor and capable of, when the switching element in a subset of the plurality of power converters has failed, interrupting a return current flowing from the switching circuit side to the power supply side in the subset of power converters.

5. The power feeding device according to claim 1, wherein each of the plurality of power converters includes a failure part detector capable of detecting the switching element in failure among the plurality of switching elements.
